(19) United States
(12) Patent Application Publication
(10) Pub. No.: US 2020/0071089 A1
(43) Pub. Date: Mar. 5, 2020

(54) Crack detection device for cylindrical parts

(71) Applicant: Xiaofeng Zhu, Shaoxing City (CN)

(72) Inventor: Xiaofeng Zhu, Shaoxing City (CN)

(21) Appl. No.: 16/677,684

(22) Filed: Nov. 8, 2019

(30) Foreign Application Priority Data
Aug. 9, 2019 (CN) 201910733731X

(51) Int. Cl. B65G 47/90; G01M 99/00

(52) U.S. Cl. CPC B65G 47/905; G01M 99/00

(57) ABSTRACT

A crack detection device for cylindrical parts includes centrifugal mechanism, which includes two stand columns (21), and a cross beam (22) is fixedly connected to the upper ends of the two stand column stand columns (21), two through holes (91) are formed in the cross beam (22), and a detection cavity (24) is formed between the cross beam (22) and the stand column (21). The traditional hand-held scanning equipment is not accurate in scanning range and has scanning holes. At the same time, it can only scan one side of the part, but still needs to turn the part manually. The lifting type automatic clamping device is adopted in the invention, which can scan the parts directly after fixing the parts.

### FIELD OF THE INVENTION

The present invention relates to a crack detection device for cylindrical parts.

### BACKGROUND OF THE INVENTION

The surface crack detection of parts is an important detection process before leaving factory. With the development of science and technology and the improvement of industrial automation level, the requirements of industrial production for the defects of parts are higher and higher. The traditional crack detection of parts mainly depends on the manual use of hand-held equipment, which has uncertain scanning scope and is prone to exist scanning hole area, making the scanning results inaccurate. At the same time, hand-held. The equipment can only scan a single direction of the part. When scanning multiple directions, the part needs to be turned manually, which is time-consuming and laborious, and the work efficiency is low.

### SUMMARY OF THE INVENTION

### Technical Issues

The traditional hand-held scanning equipment is not accurate in scanning range and has scanning holes. At the same time, it can only scan one side of the part, but still needs to turn the part manually.

In order to solve the above problems, a crack detection device for cylindrical parts is designed in this example, which comprises two stand columns, and a cross beam is fixedly connected to the upper ends of the two stand columns, wherein two through holes are formed in the cross beam, and a detection cavity is formed between the cross beam and the stand column, and the front end and the rear end of the detection cavity are communicated to the outer boundary, and a lifting block is arranged in the detection cavity in a sliding mode, and an automatic fastening device is arranged on the lower end surface of the cross beam and the upper end surface of the lifting block, the two automatic fastening devices are used for clamping parts, and a power device is arranged in the upper end surface of the lifting block, wherein the power device comprises two screw rods which are symmetric left and right, wherein the screw rod is rotationally connected to the lifting block, the upper end of the lead screw penetrates through the detection cavity and extends into the through hole, when the lifting block rises, the upper end of the lead screw can extend into the outer boundary, a detection device is arranged in the detection cavity and is matched with the lead screw through threads; the detection device can move in the detection cavity along with the rotation of the lead screw to scan the part; a lifting power device is arranged on the lower side of the power device in the lifting block; the lifting power device can be in power connection with the power device and is used for driving the lifting block to lift in the detection cavity.

The preparation method comprises the following steps: and the power device comprises two left and right symmetrical lead screw gear cavities which are positioned in the upper end surface of the lifting block, the lower end of the lead screw extends into the lead screw gear cavity and is fixedly provided with a lead screw bevel gear, and a linkage bevel gear is meshed to the symmetrical center sides of the screw rod bevel gears on the two sides, and the linkage bevel gears on the two sides are in power connection through a linkage shaft fixedly arranged at the center, and a power switching gear cavity is formed in the symmetric center sides of the lead screw gear cavities on the two sides, the linkage shaft penetrates through the power switching gear cavity and is fixedly provided with a lead screw matching gear, and a power motor is fixedly arranged in the left end wall of the power switching gear cavity, the power motor is located on the lower side of the screw rod gear cavity on the left side, the right end of the power motor is in power connection with a motor shaft, and a switching shaft is arranged on the right side of the motor shaft, the left end of the switching shaft is connected with the motor shaft through a spline, the switching shaft is positioned in the power switching gear cavity, and a switching bevel gear is fixedly arranged on the switching shaft, the upper side of the switching bevel gear can be meshed with the lead screw matching gear, the lower side of the switching bevel gear can be meshed with the lifting power device, the right side of the power switching gear cavity is provided with a switching sliding cavity, and a switching sliding block is arranged in the switching sliding cavity in a sliding mode, the right end of the switching shaft extends into the switching sliding cavity and is rotationally connected to the switching sliding block, and an air cylinder is arranged in the right end wall of the switching sliding cavity, the left end of the air cylinder is in power connection with an air cylinder push rod, the power motor can drive the lifting block to ascend and descend in the detection cavity through the lifting power device; when the switching bevel gear is meshed with the lead screw matching gear, the power motor can drive the two lead screws to rotate so as to drive the detection device to ascend and descend in the detection cavity.

The switching bevel gear is a double-sided bevel gear, so that the switching bevel gear can be meshed with the lead screw matching gear when the switching bevel gear is driven by the switching shaft to be rightwards used and is disconnected with the lead screw matching gear when moving leftwards and is meshed to the lifting power device.

The preparation method comprises the following steps: wherein the lifting power device comprises a matching shaft positioned on the lower side of the switching shaft, the matching shaft penetrates through the power switching gear cavity and is positioned in the power switching gear cavity, and a lifting matching bevel gear is fixedly arranged on the inner portion of the power switching gear cavity, the upper side of the lifting matching bevel gear can be meshed with the switching bevel gear, and a lifting gear cavity is formed in the left side and the right side of the power switching gear cavity, the left end and the right end of the matching shaft extend into the lifting gear cavity respectively and are respectively and fixedly provided with a matching bevel gear, and the rear sides of the matched bevel gears on the two sides are respectively meshed with a lifting bevel gear, and a lifting wheel shaft is fixedly arranged at the center of the lifting bevel gear, and the front side and the rear side of the lifting gear cavity are respectively provided with a lifting wheel cavity, and the front end of the lifting wheel shaft is rotationally connected to the front end wall of the front side of the lifting wheel cavity, and the rear end of the lifting wheel shaft is rotationally connected to the rear end wall of the rear side of the lifting wheel cavity, far away from the symmetric center side, of the lifting wheel; the lifting power device can be driven by the power motor to drive the lifting block to ascend and descend in the detection cavity under the driving of the power motor when the switching bevel gear is meshed with the lifting matching bevel gear.

Preferably, the outer end surface of the lifting wheel and the symmetric central side of the vertical column are of a tooth-shaped structure, so that the tightness of engagement between the lifting wheel and the stand column can be ensured.

The preparation method comprises the following steps: the detection device comprises a detection block located in the detection cavity, and the detection block is matched with the two lead screws in a threaded manner, and a detection matching cavity is formed in the end surface of the left side and the right side of the detection block, wherein a detection matching shaft is arranged in the detection matching cavity, the front end of the detection matching shaft is rotationally connected into the front end wall of the detection matching cavity, the detection matching shaft is positioned in the detection matching cavity and is fixedly provided with a detection matching wheel, the outer peripheral surface of the detection matching wheel is in a tooth shape, and the two sides of the detection matching wheel are far away from the symmetric center side and are meshed with the symmetric central side of the vertical column, and a matched gear cavity is formed in the rear side of the detection matching cavity on the two sides, and the rear ends of the detection matching shafts at the two sides extend into the matching gear cavity and are fixedly provided with a detection matching bevel gear, and a transverse shaft bevel gear is meshed to the symmetrical center sides of the two sides of the bevel gear, and the transverse shaft bevel gears on the two sides are in power connection through a detection cross shaft fixedly arranged in the center, and a screw rod cavity is formed in the symmetric center side of the cavity of the matched gear on the two sides, the detection cross shaft penetrates through the screw rod cavity and is fixedly provided with a detection screw rod, and a detection through hole is formed in the front side of the screw rod cavity, and a detection gear ring is arranged in the detection through hole in a rotating mode, a detection gear ring and a detection gear ring; the rear side of the detection gear ring extends into the screw rod cavity and is meshed with the detection screw rod; four detection units are uniformly distributed on the inner side and the rotation center side of the detection gear ring; the detection device can drive the four detection units on the upper side of the detection gear ring to rotate to scan the part through the cooperation between the detection matching wheel and the vertical column when the detection block and the screw rod are matched and lifted.

The preparation method comprises the following steps: wherein the automatic fastening device comprises two fastening blocks, and the fastening blocks on the upper side are fixedly arranged on the lower end surface of the cross beam, and the fastening blocks on the lower side are fixedly arranged on the upper end surface of the lifting block, and a buffer sliding cavity is formed in the center of the fastening block, a buffer sliding block is arranged in the buffer sliding cavity in a sliding mode, a buffer spring is arranged on the buffer sliding block in a sleeved mode, and three clamping jaw cavities are uniformly distributed in the periphery of the buffer sliding cavity in a communicated mode, and a clamping jaw rotating shaft is arranged in each clamping jaw cavity, the two ends of the clamping jaw rotating shaft are rotationally connected to the wall surface of the clamping jaw cavity; clamping jaws are fixedly arranged on the three clamping jaw rotating shafts; clamping jaw springs are fixedly arranged on the sides, far away from the symmetry center, of the three clamping jaws; the clamping jaws extend into the buffering sliding cavity to be matched with the buffering sliding blocks.

The beneficial effect of the invention is: the lifting type automatic clamping device is adopted in the invention, which can scan the parts directly after fixing the parts, and at the same time, the self rotation lifting type scanning structure is adopted to scan the parts to be tested systematically, which ensures the scanning quality and scanning speed, and automatically returns to the initial position after the scanning is completed, and the device action is carried out automatically, reducing the manual work Work to improve work efficiency.

### BRIEF DESCRIPTION OF THE DRAWINGS

For better explaining the technical proposal in the present invention embodiments or the prior art, the drawings to be used in the description of the embodiments or the prior art will be briefly described below.

FIG. 1 is an overall structural diagram of the recording system for evaluating and analyzing wind resources in this invention;

FIG. 2 is an enlarged schematic structural diagram of A in FIG. 1;

FIG. 3 is the schematic structural diagram along “B-B” direction in FIG. 2;

FIG. 4 is the schematic structural diagram along “C-C” direction in FIG. 1;

FIG. 5 is an enlarged schematic structural diagram of D in FIG. 1;

FIG. 6 is the schematic structural diagram along “E-E” direction in FIG. 5.

### DETAILED DESCRIPTION OF THE INVENTION

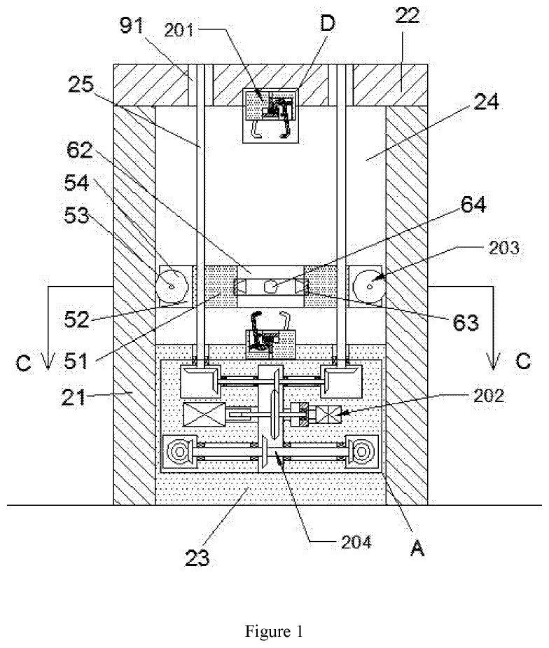

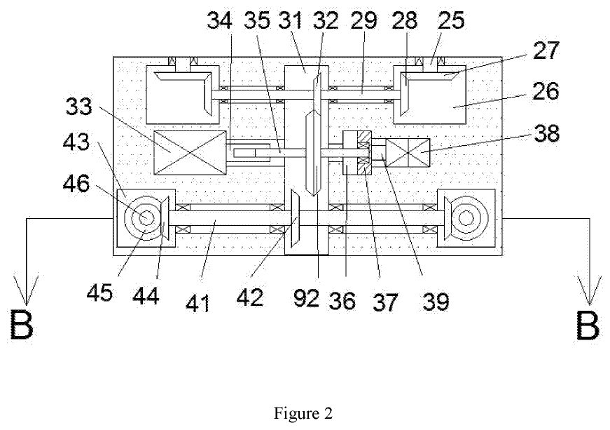

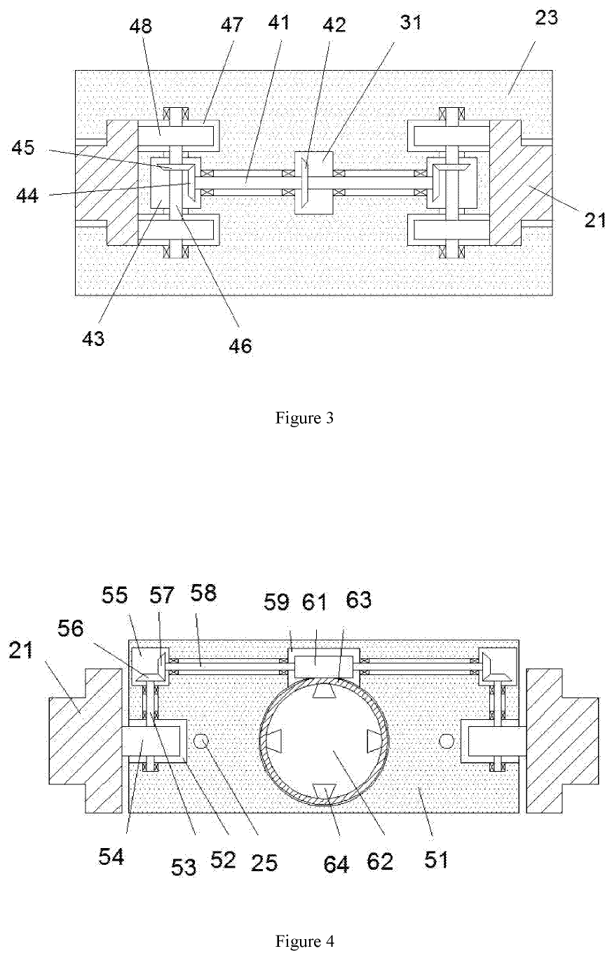

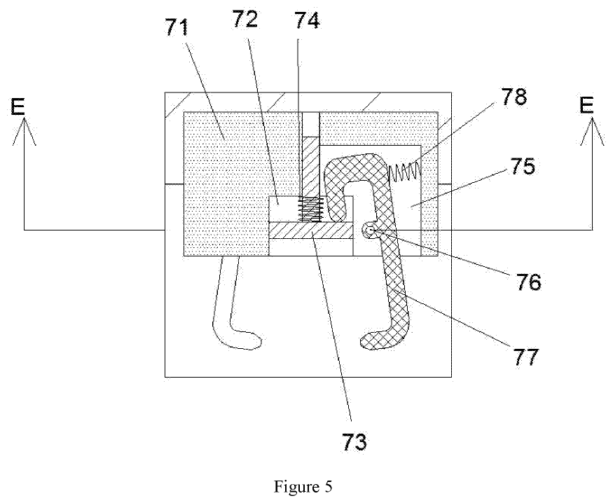

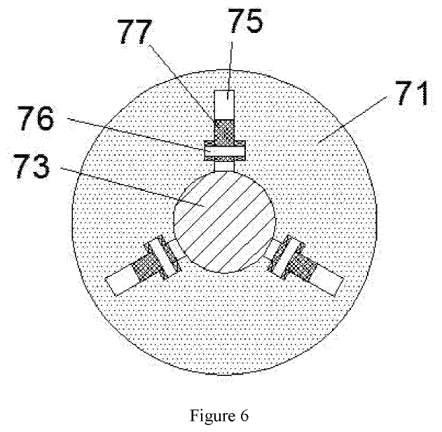

The invention will be described in detail below referring to FIGS. 1-6. For better explanation, the orientations described hereinafter are defined as follows: directions of up, down, left, right, front and rear in the text are identical to the directions of up, down, left, right, front and rear of FIG. 1.

The invention relates to a crack detection device for a cylindrical parts, which is mainly used in the process of part detection. The invention will be further described in combination with the drawings of the invention as follows:

The invention further discloses a crack detection device for a cylindrical parts, which comprises two stand columns 21, and a cross beam 22 is fixedly connected to the upper ends of the two stand column stand columns 21, two through holes 91 are formed in the cross beam 22, and a detection cavity 24 is formed between the cross beam 22 and the stand column 21, the front end and the rear end of the detection cavity 24 are communicated to the outer boundary, a lifting block 23 is arranged in the detection cavity 24 in a sliding mode, and an automatic fastening device 201 is arranged on the lower end surface of the cross beam 22 and the upper end surface of the lifting block 23, the two automatic fastening devices 201 are used for clamping parts, a power device 202 is arranged in the upper end surface of the lifting block 23, wherein the power device 202 comprises two screw rods 25 which are symmetrical left and right, and the lead screw 25 is rotationally connected to the lifting block 23, the upper end of the lead screw 25 penetrates through the detection cavity 24 and extends into the through hole 91, when the lifting block 23 rises, the upper end of the lead screw 25 can extend into the outer boundary, a detection device 203 is arranged in the detection cavity 24, a lifting power device 204 is arranged on the lower side of the power device 202 in the lifting block 23 and can be in power connection with the power device 202 and used for driving the lifting block 23 to ascend and descend in the detection cavity 24.

According to an embodiment, the power device 202 is described in detail below, the power device 202 comprises two left and right symmetrical lead screw gear cavities 26 located in the upper end surface of the lifting block 23, the lower end of the lead screw 25 extends into the lead screw gear cavity 26 and is fixedly provided with a lead screw bevel gear 27, and a linkage bevel gear 28 is meshed to the symmetrical center sides of the lead screw bevel gears 27 on the two sides, and the linkage bevel gears 28 on the two sides are in power connection through a linkage shaft 29 which is fixedly arranged at the center, and a power switching gear cavity 31 is arranged on the symmetrical central sides of the lead screw gear cavities 26 on the two sides, the linkage shaft 29 penetrates through the power switching gear cavity 31 and is fixedly provided with a lead screw matching gear 32, a power motor 33 is fixedly arranged in the left end wall of the power switching gear cavity 31, the power motor 33 is located on the lower side of the screw rod gear cavity 26 on the left side, and the right end of the power motor 33 is in power connection with a motor shaft 34, and a switching shaft 35 is arranged on the right side of the motor shaft 34, the left end of the switching shaft 35 is connected with the motor shaft 34 through a spline, the switching shaft 35 is positioned in the power switching gear cavity 31 and is fixedly provided with a switching bevel gear 92, and the upper side of the switching bevel gear 92 can be meshed with the lead screw matching gear 32, the lower side of the switching bevel gear 92 can be meshed with the lifting power device 204, a switching sliding cavity 36 is formed in the right side of the power switching gear cavity 31, and a switching sliding block 37 is arranged in the switching sliding cavity 36 in a sliding mode, the right end of the switching shaft 35 extends into the switching sliding cavity 36 and is rotationally connected to the switching sliding block 37, and an air cylinder 38 is arranged in the right end wall of the switching sliding cavity 36, and an air cylinder push rod 39 is connected to the power of the left end of the air cylinder 38, and the left end of the cylinder push rod 39 is fixedly connected to the right end surface of the switching slide block 37, the power motor 33 can drive the lifting block 23 to lift in the detection cavity 24 through the lifting power device 204; when the switching bevel gear 92 is engaged with the lead screw matching gear 32, the power motor 33 can drive the two lead screws 25 to rotate so as to drive the detection device 203 to lift in the detection cavity 24.

Advantageously, the switching bevel gear 92 is a double-sided bevel gear, so that the switching bevel gear 92 can be meshed with the lead screw matching gear 32 when the switching shaft 35 is driven by the switching shaft 35, and is disconnected from the lead screw matching gear 32 when the switching bevel gear 92 moves leftwards and is meshed to the lifting power device 204.

According to an embodiment, the lifting power device 204 is described in detail below, the lifting power device 204 comprises a matching shaft 41 located on the lower side of the switching shaft 35, the matching shaft 41 penetrates through the power switching gear cavity 31 and is positioned in the power switching gear cavity 31, and a lifting matching bevel gear 42 is fixedly arranged on the inner portion of the power switching gear cavity 31, the upper side of the lifting matching bevel gear 42 can be meshed with the switching bevel gear 92, and a lifting gear cavity 43 is formed in the left side and the right side of the power switching gear cavity 31, and the left end and the right end of the matching shaft 41 extend into the lifting gear cavity 43 respectively and are fixedly provided with a matching bevel gear 44, and the rear side of the matching bevel gear 44 on the two sides is meshed with a lifting bevel gear 45, and a lifting wheel shaft 46 is fixedly arranged at the center of the lifting bevel gear 45, and a lifting gear cavity 47 is arranged on the front side and the rear side of the lifting gear cavity 43 on the two sides, the front end of the lifting wheel shaft 46 is rotationally connected to the front end wall of the front side of the lifting wheel cavity 47, and the rear end of the lifting wheel shaft 46 is rotationally connected to the rear end wall of the rear side of the lifting wheel cavity 47, the lifting wheel shaft 46 is located on the inner portion of the lifting wheel cavity 47, and a lifting wheel 48 is fixedly arranged on the lifting wheel shaft 46, the lifting power device 204 can be driven by the power motor 33 to drive the lifting block 23 to ascend and descend in the detection cavity 24 under the driving of the power motor 33 when the switching bevel gear 92 is meshed with the lifting matching bevel gear 42.

Advantageously, the outer end surface of the lifting wheel 48 and the symmetric central side of the stand column 21 are of a tooth-shaped structure, so that the tightness of engagement between the lifting wheel 48 and the stand column 21 can be ensured.

According to an embodiment, the detection device 203 is described in detail below, the detection device 203 comprises a detection block 51 located in the detection cavity 24, the detection block 51 is in threaded fit with the two lead screws 25, and a detection matching cavity 52 is formed in the end surface of the left side and the right side of the detection block 51, a detection matching shaft 53 is arranged in the detection matching cavity 52, the front end of the detection matching shaft 53 is rotationally connected to the front end wall of the detection matching cavity 52, the detection matching shaft 53 is positioned in the detection matching cavity 52 and is fixedly provided with a detection matching wheel 54, the outer peripheral surface of the detection matching wheel 54 is in a tooth shape, and the detection matching wheels 54 on the two sides are away from the symmetric center side and are meshed to the symmetric center side of the stand column 21, and a matched gear cavity 55 is formed in the rear side of the detection matching cavity 52 on the two sides, and the rear end of the detection matching shaft 53 and the rear end of the detection matching shaft 53 extend into the matching gear cavity 55 and are fixedly provided with a detection matching bevel gear 56, and a transverse shaft bevel gear 57 is meshed with the symmetrical center sides of the bevel gears 56 on the two sides, and the transverse shaft bevel gears 57 on the two sides are in power connection through a detection cross shaft 58 which is fixedly arranged in the center, and a screw rod cavity 59 is formed in the symmetric center side of the matching gear cavities 55 on the two sides, the detection cross shaft 58 penetrates through the screw rod cavity 59 and is fixedly provided with a detection screw rod 61, the front side of the screw rod cavity 59 is provided with a detection through hole 62, and a detection gear ring 63 is rotationally arranged in the detection through hole 62, the rear side of the detection gear ring 63 is located in the screw rod cavity 59 and is meshed with the detection screw rod 61, the inner side of the detection gear ring 63 is uniformly provided with four detection units 64; the detection device 203 can drive the four detection units 64 on the upper side of the detection gear ring 63 to rotate through the cooperation of the detection matching wheel 54 and the upright post 21 when the detection block 51 and the lead screw 25 are matched and lifted.

According to an embodiment, the automatic fastening device 201 is described in detail below, the automatic fastening device 201 comprises two fastening blocks 71, and the fastening block 71 on the upper side is fixedly arranged on the lower end surface of the cross beam 22, and the fastening block 71 on the lower side is fixedly arranged on the upper end surface of the lifting block 23, a buffer sliding cavity 72 is formed in the center of the fastening block 71, a buffer sliding block 73 is arranged in the buffer sliding cavity 72 in a sliding mode, the buffer sliding block 73 is sleeved with a buffer spring 74, and three clamping jaw cavities 75 are uniformly distributed in the periphery of the buffer sliding cavity 72, and a clamping jaw rotating shaft 76 is arranged in each clamping jaw cavity 75, the two ends of the clamping jaw rotating shaft 76 are rotationally connected to the wall surface of the clamping jaw cavity 75, a clamping jaw 77 is fixedly arranged on the three clamping jaw rotating shafts 76, a clamping jaw spring 78 is fixedly arranged on the side, far away from the symmetry center, of the three clamping jaws 77, the clamping jaw 77 extends into the buffering sliding cavity 72 to be matched with the buffering sliding block 73, and when the part presses the buffering sliding block 73, the three clamping jaws 77 are driven to clamp towards the symmetrical central side.

The use steps of the crack detection device for columnar parts are described in detail below with reference to FIGS. 1-6.

In the initial state, the lower end surface of the lifting block 23 is abutted against the lower end wall of the detection cavity 24, the lower end of the detection block 51 is abutted against the upper end surface of the lifting block 23, the lower side of the automatic fastening device 201 extends into the detection through hole 62 of the lower side, the left end of the switching slide block 37 abuts against the left end wall of the switching sliding cavity 36, the switching bevel gear 92 is meshed with the lifting matching bevel gear 42, and the power motor 33 does not act.

When the device starts to work, the part is vertically placed in the detection through hole 62 to enable the lower end of the part to abut against the upper end surface of the buffer slide block 73 at the lower side, starting the power motor 33, the switching shaft 35 is driven by the motor shaft 34, and then the matching shaft 41 is driven to rotate through the engagement between the switching bevel gear 92 and the lifting matching bevel gear 42, is meshed with the lifting bevel gear 45 through the matching bevel gear 44, so as to drive the lifting wheel shafts 46 on the two sides to rotate, so as to drive the lifting wheel to rotate, and the lifting wheel 48 is meshed with the stand column 21 to enable the lifting block 23 to move upwards, when the upper end of the part abuts against the lower end surface of the buffer sliding block 73 on the upper side, and the clamping claws 77 on the upper side and the lower side are used for clamping parts to the symmetric center sides, after the fixing is stable, and the air cylinder 38 drives the switching sliding block 37 to move rightwards through the air cylinder push rod 39, so as to drive the switching bevel gear 92 to move rightwards, when the right end of the switching sliding block 37 abuts against the right end wall surface of the switching sliding cavity 36, the switching bevel gear 92 is meshed with the linkage shaft 29 to drive the linkage shaft 29 to rotate, and then the lead screw 25 on the two sides is driven to rotate through the meshing of the linkage bevel gear 28 and the lead screw bevel gear 27, so that the detection block 51 moves upwards, and the detection matching wheel 54 is meshed with the stand column 21 to drive the detection matching shaft 53 to rotate, and then the bevel gear 56 is meshed with the transverse shaft bevel gear 57 to drive the detection cross shaft 58 to rotate, and the detection gear ring 63 is driven to rotate through the meshing of the detection screw rod 61 and the detection gear ring 63, so as to drive the four detection units 64 to rotate, when the detection block 51 begins to rise, wherein the detection unit 64 is started, scanning the parts, and when the detection block 51 moves upwards to the upper end surface of the detection block 51, the detection block 51 abuts against the upper end wall of the detection cavity 24, the power motor 33 reversely rotates, so as to enable the lead screw 25 to rotate reversely, so that the detection block 51 moves downwards, and the detection gear ring 63 is enabled to rotate reversely, when the lower end surface of the detection block 51 is abutted against the upper end surface of the lifting block 23, so that the switching bevel gear 92 is engaged with the lifting matching bevel gear 42 to further drive the lifting wheel 48 to rotate, so that the lifting block 23 moves downwards; when the lower end surface of the lifting block 23 abuts against the lower end wall of the detection cavity 24, the power motor 33 stops, the part can be taken out at the moment, and the device returns to the initial state.

The beneficial effect of the invention is: the lifting type automatic clamping device is adopted in the invention, which can scan the parts directly after fixing the parts, and at the same time, the self rotation lifting type scanning structure is adopted to scan the parts to be tested systematically, which ensures the scanning quality and scanning speed, and automatically returns to the initial position after the scanning is completed, and the device action is carried out automatically, reducing the manual work Work to improve work efficiency.

In the above manner, those skilled in the art can make various changes according to the working mode within the scope of the invention.

1. A crack detection device for cylindrical parts, comprises:
two stand columns,
and a cross beam is fixedly connected to the upper ends of the two stand columns,
wherein two through holes are formed in the cross beam,
and a detection cavity is formed between the cross beam and the stand column,
and the front end and the rear end of the detection cavity are communicated to the outer boundary,
and a lifting block is arranged in the detection cavity in a sliding mode,
and an automatic fastening device is arranged on the lower end surface of the cross beam and the upper end surface of the lifting block, the two automatic fastening devices are used for clamping parts,
and a power device is arranged in the upper end surface of the lifting block,
wherein the power device comprises two screw rods which are symmetric left and right,
wherein the screw rod is rotationally connected to the lifting block, the upper end of the lead screw penetrates through the detection cavity and extends into the through hole, when the lifting block rises, the upper end of the lead screw can extend into the outer boundary,
a detection device is arranged in the detection cavity and is matched with the lead screw through threads; the detection device can move in the detection cavity along with the rotation of the lead screw to scan the part;
a lifting power device is arranged on the lower side of the power device in the lifting block;
the lifting power device can be in power connection with the power device and is used for driving the lifting block to lift in the detection cavity.

2. The crack detection device for cylindrical parts as defined in claim 1, wherein the power device comprises two left and right symmetrical lead screw gear cavities which are positioned in the upper end surface of the lifting block, the lower end of the lead screw extends into the lead screw gear cavity and is fixedly provided with a lead screw bevel gear,
and a linkage bevel gear is meshed to the symmetrical center sides of the screw rod bevel gears on the two sides,
and the linkage bevel gears on the two sides are in power connection through a linkage shaft fixedly arranged at the center,
and a power switching gear cavity is formed in the symmetric center sides of the lead screw gear cavities on the two sides, the linkage shaft penetrates through the power switching gear cavity and is fixedly provided with a lead screw matching gear,
and a power motor is fixedly arranged in the left end wall of the power switching gear cavity, the power motor is located on the lower side of the screw rod gear cavity on the left side, the right end of the power motor is in power connection with a motor shaft,
and a switching shaft is arranged on the right side of the motor shaft, the left end of the switching shaft is connected with the motor shaft through a spline, the switching shaft is positioned in the power switching gear cavity,
and a switching bevel gear is fixedly arranged on the switching shaft, the upper side of the switching bevel gear can be meshed with the lead screw matching gear, the lower side of the switching bevel gear can be meshed with the lifting power device, the right side of the power switching gear cavity is provided with a switching sliding cavity,
and a switching sliding block is arranged in the switching sliding cavity in a sliding mode, the right end of the switching shaft extends into the switching sliding cavity and is rotationally connected to the switching sliding block,
and an air cylinder is arranged in the right end wall of the switching sliding cavity, the left end of the air cylinder is in power connection with an air cylinder push rod, the power motor can drive the lifting block to ascend and descend in the detection cavity through the lifting power device; when the switching bevel gear is meshed with the lead screw matching gear, the power motor can drive the two lead screws to rotate so as to drive the detection device to ascend and descend in the detection cavity.

3. The crack detection device for cylindrical parts as defined in claim 2, wherein the switching bevel gear is a double-sided bevel gear, so that the switching bevel gear can be meshed with the lead screw matching gear when the switching bevel gear is driven by the switching shaft to be rightwards used and is disconnected with the lead screw matching gear when moving leftwards and is meshed to the lifting power device.

4. The crack detection device for cylindrical parts as defined in claim 1, wherein the lifting power device comprises a matching shaft positioned on the lower side of the switching shaft,
the matching shaft penetrates through the power switching gear cavity and is positioned in the power switching gear cavity,
and a lifting matching bevel gear is fixedly arranged on the inner portion of the power switching gear cavity, the upper side of the lifting matching bevel gear can be meshed with the switching bevel gear,
and a lifting gear cavity is formed in the left side and the right side of the power switching gear cavity, the left end and the right end of the matching shaft extend into the lifting gear cavity respectively and are respectively and fixedly provided with a matching bevel gear,
and the rear sides of the matched bevel gears on the two sides are respectively meshed with a lifting bevel gear,
and a lifting wheel shaft is fixedly arranged at the center of the lifting bevel gear,
and the front side and the rear side of the lifting gear cavity are respectively provided with a lifting wheel cavity,
and the front end of the lifting wheel shaft is rotationally connected to the front end wall of the front side of the lifting wheel cavity, and the rear end of the lifting wheel shaft is rotationally connected to the rear end wall of the rear side of the lifting wheel cavity, far away from the symmetric center side, of the lifting wheel; the lifting power device can be driven by the power motor to drive the lifting block to ascend and descend in the detection cavity under the driving of the power motor when the switching bevel gear is meshed with the lifting matching bevel gear.

5. The crack detection device for cylindrical parts as defined in claim 4, wherein the outer end surface of the lifting wheel and the symmetric central side of the vertical column are of a tooth-shaped structure, so that the tightness of engagement between the lifting wheel and the stand column can be ensured.

6. The crack detection device for cylindrical parts as defined in claim 1, wherein the detection device comprises a detection block located in the detection cavity,
and the detection block is matched with the two lead screws in a threaded manner,
and a detection matching cavity is formed in the end surface of the left side and the right side of the detection block,
wherein a detection matching shaft is arranged in the detection matching cavity, the front end of the detection matching shaft is rotationally connected into the front end wall of the detection matching cavity, the detection matching shaft is positioned in the detection matching cavity and is fixedly provided with a detection matching wheel, the outer peripheral surface of the detection matching wheel is in a tooth shape,
and the two sides of the detection matching wheel are far away from the symmetric center side and are meshed with the symmetric central side of the vertical column, and a matched gear cavity is formed in the rear side of the detection matching cavity on the two sides,
and the rear ends of the detection matching shafts at the two sides extend into the matching gear cavity and are fixedly provided with a detection matching bevel gear, and a transverse shaft bevel gear is meshed to the symmetrical center sides of the two sides of the bevel gear,
and the transverse shaft bevel gears on the two sides are in power connection through a detection cross shaft fixedly arranged in the center,
and a screw rod cavity is formed in the symmetric center side of the cavity of the matched gear on the two sides, the detection cross shaft penetrates through the screw rod cavity and is fixedly provided with a detection screw rod,
and a detection through hole is formed in the front side of the screw rod cavity,
and a detection gear ring is arranged in the detection through hole in a rotating mode,
a detection gear ring and a detection gear ring; the rear side of the detection gear ring extends into the screw rod cavity and is meshed with the detection screw rod;
our detection units are uniformly distributed on the inner side and the rotation center side of the detection gear ring; the detection device can drive the four detection units on the upper side of the detection gear ring to rotate to scan the part through the cooperation between the detection matching wheel and the vertical column when the detection block and the screw rod are matched and lifted.

7. The crack detection device for cylindrical parts as defined in claim 1, wherein the automatic fastening device comprises two fastening blocks,
and the fastening blocks on the upper side are fixedly arranged on the lower end surface of the cross beam,
and the fastening blocks on the lower side are fixedly arranged on the upper end surface of the lifting block,
and a buffer sliding cavity is formed in the center of the fastening block,
a buffer sliding block is arranged in the buffer sliding cavity in a sliding mode,
a buffer spring is arranged on the buffer sliding block in a sleeved mode,
and three clamping jaw cavities are uniformly distributed in the periphery of the buffer sliding cavity in a communicated mode,
and a clamping jaw rotating shaft is arranged in each clamping jaw cavity, the two ends of the clamping jaw rotating shaft are rotationally connected to the wall surface of the clamping jaw cavity;
clamping jaws are fixedly arranged on the three clamping jaw rotating shafts;
clamping jaw springs are fixedly arranged on the sides, far away from the symmetry center, of the three clamping jaws; the clamping jaws extend into the buffering sliding cavity to be matched with the buffering sliding blocks.
